(19) United States
(12) Patent Application Publication
(10) Pub. No.: US 2003/0173431 A1
(43) Pub. Date: Sep. 18, 2003

(54) Reclaimer device and method thereof

(76) Inventors: Kevin Hood, Lawrenceville, GA (US); Bengt Nilsson, Duluth, GA (US); Chris Waller, Duluth, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/391,972

(22) Filed: Mar. 18, 2003

Related U.S. Application Data
(60) Provisional application No. 60/365,109, filed on Mar. 18, 2002.

(51) Int. Cl. B02C 13/26

(52) U.S. Cl. 241/27; 241/73; 241/189.1

(57) ABSTRACT

An improved reclaimer device and a method thereof, wherein overall efficiency is maximized via decreased installation and operation costs, and wherein performance is optimized via aggressive treatment of reclaimed bulk material prior to and during exit from the reclaim boom, thereby minimizing costly downtime by preventing jams caused by clumped materials and ensuring the efficient passage of appropriately sized bulk materials from a preferred, generally horizontal conveyor into an out-feed chute and conveyor.

### CROSS-REFERENCE TO RELATED APPLICATION

To the full extent permitted by law, the present application claims priority to and the benefit as a non-provisional application to provisional patent application entitled “Reclaimer Device and Method Thereof” filed on Mar. 18, 2002, having assigned Serial No. 60/365,109.

### TECHNICAL FIELD

The present invention relates generally to stacker/reclaimer devices and, more specifically, to an improved reclaimer device and a method thereof, wherein reclaimed bulk material is aggressively manipulated prior to exiting the reclaim boom, thereby ensuring the passage of appropriately sized bulk materials into the out-feed chute and conveyor, thus preventing jams caused by clumped materials. The present invention is particularly suited for, although not limited to, stacker/reclaimer utilization enabling a user to stack, blend and reclaim wood chips year-round without experiencing jams and costly downtime resulting from inclimate weather conditions or otherwise agglomerated chips.

### BACKGROUND OF THE INVENTION

Stacker/reclaimer devices are utilized for a variety of bulk material applications such as, for exemplary purposes only, stacking, blending and reclaiming wood chips and bark for the pulp and paper industry, limestone for the cement industry, crushed stone for aggregate processors, coal and/or ore for mining and power operations, general bulk materials for the marine industry, and urea, nitrate and phosphate for fertilizer applications. Automated stacking and reclaiming of stockpiles enables the realization of substantial reductions in operating costs, wherein power consumption, manpower requirements and maintenance costs are minimized.

Unplanned, costly downtime can result from the jamming of oversized or clumped reclaimed materials. Such oversized or clumped materials may include, for example, agglomerated bark, substantial limestone or coal components resulting from unsuccessful pulverization, or wet or frozen bulk materials that are not suitably loose for free processing. In an effort to diminish the negative impact of frozen materials, ice-breaking receptacles have been incorporated into some stacker/reclaimer systems, wherein frozen material sections exit the reclaimer boom to pass downward between spiked cylinders or through a scalping screen before falling downward to a removal conveyor and being taken upward into the base of the central tower to fall through a chute onto an out-feed conveyor. The available systems, however, are disadvantageous in view of the present invention.

For instance, requiring reclaimed bulk materials to pass downward between spiked cylinders or through a scalping screen requires an increased structural height and/or necessitates the subsequent passage upward via a removal conveyor into the central tower for out-feed. In order to avoid harsh vertical angles between the base of the reclaim boom and the top of the out-feed chute,,a lengthy removal conveyor is required. This elongated removal conveyor generates increased installation and operational costs by requiring a large pit area with an expanded concrete foundation and, wherein the removal conveyor is typically a screw conveyor, by requiring the utilization of lengthy screws. Moreover, agglomerated bulk materials may jam the reclaimer boom conveyor mechanism during exit from the reclaimer boom, hindering or preventing the advancement of the oversized clumps downward toward spiked cylinders or a scalping screen and potentially damaging costly reclaimer mechanisms.

Therefore, it is readily apparent that there is a need for an improved reclaimer device and a method thereof, wherein reclaimed bulk material is aggressively manipulated prior to exiting the reclaim boom, thereby efficiently ensuring the entry of appropriately sized bulk materials into the out-feed chute and conveyor, thus preventing the above-discussed disadvantages.

### BRIEF SUMMARY OF THE INVENTION

Briefly described, in a preferred embodiment, the present invention overcomes the above-mentioned disadvantages and meets the recognized need for such a device by providing an improved reclaimer device-and a method thereof, wherein performance is optimized via aggressive treatment of bulk material prior to exit from the reclaim boom, thus minimizing costly downtime, and wherein overall efficiency is maximized via decreased installation and operational costs.

According to its major aspects and broadly stated, the present invention is an improved reclaimer device and a method thereof, wherein reclaimed bulk material is aggressively manipulated prior to exiting the reclaim boom, thereby preventing jams caused by clumped materials and ensuring the efficient passage of appropriately sized bulk materials into an out-feed chute and conveyor, preferably from a metering conveyor.

More specifically, the present invention is an improved reclaimer device having a bulk material breaking means preferably positioned between the base of the bulk material pile and a transfer chute to a conveyor, wherein breakage of any oversized bulk materials occurs substantially prior to and during exit of such materials from a reclaimer conveyor. The breaking means is mounted to enable movement with the reclaimer conveyor and includes a plurality of discs mounted on a rotating shaft.

Each disc or plate has a generally circular shape surrounded by a plurality of aggressive teeth. Although generally flat discs or plates with generally flat triangular shaped projections are preferred, one skilled in the art would readily recognize that alternatively shaped projections could be utilized such as, for exemplary purposes only, conical, cylindrical or pyramidal shaped projections, without affecting the intended scope or anticipated applications of the present invention. The plurality of discs are axially aligned on a shaft mounted proximate to the pivot of the reclaimer boom, or assembly, wherein a motor and linkage commonly available in the art are preferably utilized to generate rotation of the shaft, and thus rotation of the generally saw-toothed wheels.

A transfer chute is positioned proximate to the base of the reclaimer boom, preferably within and proximate to a peripheral wall generally encircling the slew drive, wherein the peripheral wall prevents undesired passage of pile materials and wherein the transfer chute preferably directs reclaimed bulk materials onto a generally horizontal screw conveyor following treatment by the jagged plates. One skilled in the art would readily recognize that a linear traveling. reclaimer could alternately be utilized for appropriate applications in lieu of a circular slewing reclaimer. In the preferred embodiment, the transfer chute and screw conveyor, like the breaking means, are mounted so as to move with the reclaimer conveyor. The screw conveyor generally meters the reclaimed bulk material and directs it into the base of the central tower, wherein it falls through an exit chute onto an out-feed conveyor. It should be noted that, although it is preferred that a screw conveyer be utilized to direct and meter bulk materials from the transfer chute into the base of the central tower, the transfer chute could be configured to guide bulk materials directly into the base of the central tower without an interim transfer means. Moreover, although it is preferred that the screw conveyor be positioned generally horizontally, the screw conveyor could be positioned at any angle necessary to enable accommodation of requirements of the particular application and site conditions.

A feature and advantage of the present invention is the ability of such a method and device to enable aggressive manipulation of reclaimed bulk materials generally prior to exiting the reclaim boom, thereby ensuring the passage of appropriately sized bulk materials into the out-feed chute and conveyor.

Another feature and advantage of the present invention is the ability of such a method and device to enable metering of reclaimed bulk materials, thereby ensuring the passage of generally consistent quantities of materials into the out-feed chute and conveyor.

Another feature and advantage of the present invention is the ability of such a method and device to prevent blockage of a reclaimer, thus alleviating costly downtime.

Another feature and advantage of the present invention is the ability of such a method and device to prevent jams caused by clumped materials.

Another feature and advantage of the present invention is the ability of such a method and device to enable a user to stack, blend and reclaim wood chips year-round without experiencing jams and costly downtime resulting from inclimate weather conditions or otherwise agglomerated chips.

Another feature and advantage of the present invention is the ability of such a method and device to maximize overall efficiency via decreased installation and operational costs.

Another feature and advantage of the present invention is the ability of such a method and device to loosen and free oversized or clumped bulk materials such as, for exemplary purposes only, agglomerated bark, substantial limestone or coal components resulting from unsuccessful pulverization, or wet or frozen bulk materials.

Another feature and advantage of the present invention is the ability of such a method and device to break oversized reclaimed bulk materials without necessitating the subsequent passage upward via a removal conveyor into a central tower for out-feed, yet without eliminating the capacity for upward removal if conditions so dictate.

Another feature and advantage of the present invention is the ability of such a method and device to minimize installation costs by eliminating the need for a large pit area and/or expanded concrete foundation.

Another feature and advantage of the present invention is the ability of such a method and device to minimize operational costs by eliminating the necessity for lengthy conveyor screws, thus decreasing power consumption, wear, maintenance and overall installation and operating costs.

Another feature and advantage of the present invention is the ability of such a method and device to enable efficient single stage processing of all agglomerated bulk materials.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a reclaimer apparatus according to a preferred embodiment of the present invention, showing the reclaimer boom in a generally lowered position.

FIG. 2 is a perspective view of the reclaimer apparatus of FIG. 1, showing the reclaimer boom in a generally raised position.

FIG. 3 is a perspective view of the reclaimer apparatus of FIG. 1, showing a breaking mechanism positioned on the reclaimer boom, a transfer chute, and generally horizontal screw conveyor, according to a preferred embodiment of the present invention.

FIG. 4 is a side view of a reclaimer apparatus according to an alternate embodiment of the present invention, showing a second breaking mechanism positioned proximate to the first breaking mechanism.

FIG. 5 is a top view of the reclaimer apparatus of FIG. 4 taken along line 5-5, showing the second breaking mechanism.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

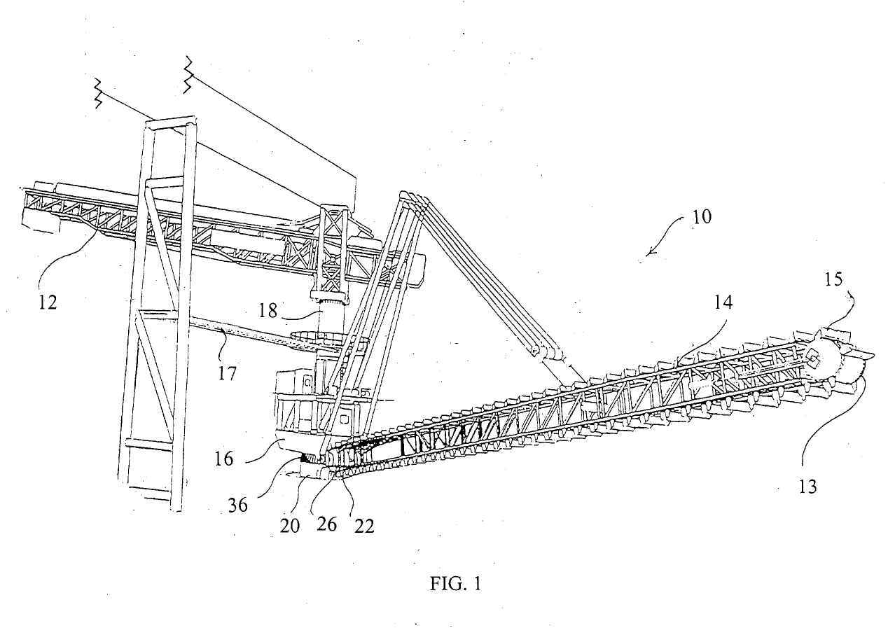

Referring now to FIG. 1, the present invention is an improved reclaimer device 10, wherein stacker boom 12 is supported by upper tower 18 and reclaimer assembly 14 is supported by main frame 16. Stacker boom 12, any stacker boom known in the art, and upper tower 18 are rotationally mounted proximate to stationary torque arm 17, wherein rotation of stacker boom 12 and upper upper tower 18 relative to torque arm 17 is enabled via means known in the art. Main frame 16 is rotationally mounted to stationary foundation 20. The configuration as described allows independent rotation of stacker boom 12 and reclaimer assembly 14 about a central axis. To accommodate alternate stacking or reclaiming methodologies or any other use requiring alternately shaped piles, any known tower and boom configuration could be utilized, wherein the improvement further described herein could be incorporated therewith. For example, to reclaim materials from the side, a luffing boom scraper, a portal style reclaimer, a semi-portal reclaimer or a cantilever style reclaimer could be utilized, with a bridge type reclaimer enabling the reclaim of materials from the end face of a pile. Thus, whether circular or linear, whether provided with one chain or a plurality of chains or rake attachments, and irrespective of the facility and application style specifications, any known or anticipated reclaimer assembly may effectively incorporate the invention and improvement described herein.

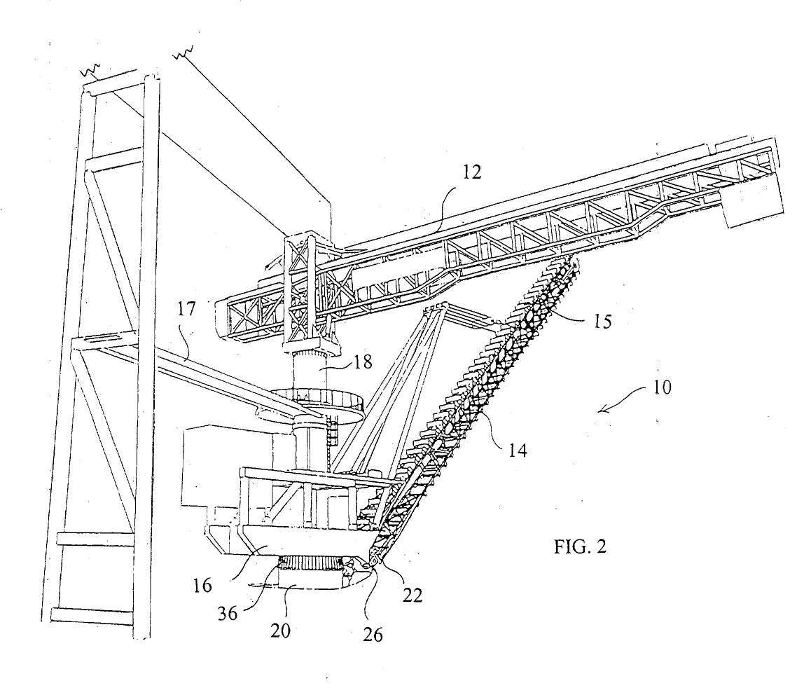

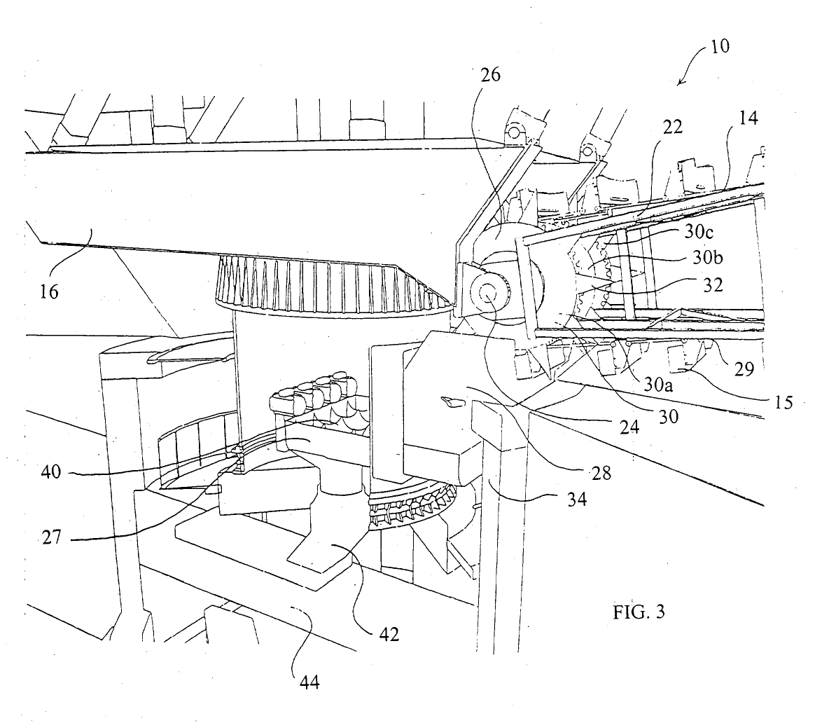

Preferred reclaimer assembly 14 is rotationally mounted proximate to main frame 16, wherein reclaimer chain 13 enables movement of the plurality of rakes 15 to reclaim bulk material from a pile. As best seen in FIG. 3, tail end 22 of reclaimer assembly 14 is pivotally mounted on shaft 24, wherein movement of reclaimer assembly 14 relative to shaft 24 enables downward and upward movement of reclaimer assembly 14, as best seen in FIGS. 1 and 2, respectively. Preferably, bulk material breaking means 26 is rotationally mounted on shaft 24, whereby movement of preferred transfer conveyor 27 and bulk material breaking means 26 is linked.

Preferably, the mounting of bulk material breaking means 26 on shaft 24 proximate to tail end 22 of reclaimer assembly 14 results in bulk material breaking means 26 being positioned between the base of the bulk material pile and transfer chute 28, thereby enabling breakage of oversized bulk materials to occur substantially prior to and during exit of such materials. Bulk material breaking means 26 preferably includes a plurality of discs 30 axially aligned on rotating shaft 24, proximate to the pivot of reclaimer assembly 14, wherein movement of preferred transfer conveyor 27 and preferably coincident rotation of shaft 24 initiates cooperative rotational movement of plurality of discs 30. Preferably, a motor and linkage known in the art are utilized to generate rotation of shaft 24, and thereby rotation of the generally saw-toothed wheels 30a, 30b and 30c of the plurality of discs 30.

In the preferred embodiment, bulk material breaking means 26 has three discs or plates 30a, 30b and 30c of the plurality of discs 30, wherein each disc or plate 30a, 30b and 30c preferably is generally circular-shaped and surrounded by a plurality of aggressive teeth 32. Although three discs are preferred, one skilled in the art would readily recognize that any number of discs could be utilized. Moreover, although generally flat discs or plates 30a, 30b and 30c with generally flat triangular-shaped projections 32 are preferred, one skilled in the art would readily recognize that alternatively shaped projections could be utilized such as, for exemplary purposes only, conical, cylindrical or pyramidal shaped projections, without affecting the intended scope or anticipated applications of the present invention.

Transfer chute 28 is preferably positioned proximate to tail end 22 of reclaimer assembly 14, preferably within and proximate to peripheral wall 34. Peripheral wall 34 generally encircles slew bearing 36 of main frame 16, thereby functioning to prevent undesired passage of pile materials into slew bearing 36 of main frame 16. Transfer chute 28 receives loose bulk materials from reclaimer conveyor 29 and preferably directs the materials onto generally transfer conveyor 27, preferably a generally horizontal screw conveyor. Although a generally horizontal position is preferred for transfer conveyor 27, it is anticipated that other non-horizontal positions could also be employed, for instance, to enable specialized site accommodations. Transfer conveyor 27 is preferably a screw conveyor having a plurality of rotating augers 40, preferably powered by means known in the art. The preferred generally horizontal screw embodiment of transfer conveyor 27 enables metering of reclaimed bulk materials, wherein a consistent flow may be directed therefrom with maximized efficiency. However, while it is preferred that transfer chute 28 direct reclaimed bulk material onto screw conveyor 27, improved reclaimer device 10 could be constructed without transfer conveyor 27, wherein transfer chute 28 could pass reclaimed bulk materials essentially directly through exit chute 42.

Transfer chute 28 and screw conveyor 27, like bulk material breaking means 26, are mounted so as to move with reclaimer conveyor 28. Preferably, screw conveyor 27 generally horizontally directs reclaimed bulk material into the central axis of foundation 20 of main frame 16, wherein the reclaimed bulk material falls through exit chute 42 onto out-feed conveyor 44.

In an alternate embodiment, screw conveyor 27 could be any means of metering and conveyance positioned at any angle, wherein bulk material could be directed thereby to out-feed conveyor 44.

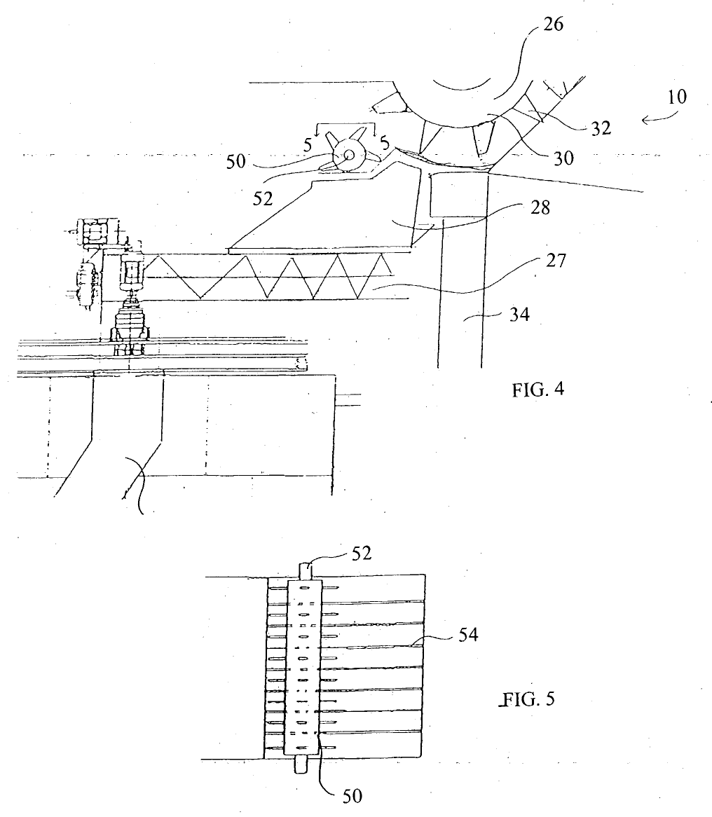

In an alternate embodiment, as best seen in FIG. 4, second bulk material breaking means 50 could be mounted on second shaft 52, wherein bulk material could be substantially directed from bulk material breaking means 26 to second bulk material breaking means 50 and whereby movement of reclaimer conveyor 29 and bulk material breaking means 26 could be linked by any means known in the art such as, for exemplary purposes only, a belt, chain drive, gear mechanism or any other appropriate means.

In an alternate embodiment, as best seen in FIG. 4, second bulk material breaking means 50 could be mounted on second shaft 52, wherein bulk material could be substantially directed from bulk material breaking means 26 to second bulk material breaking means 50 whereby movement of reclaimer conveyor 29 and bulk material breaking means 26 could be independent.

In an alternate embodiment, as best seen in FIGS. 4 and 5, second bulk material breaking means 50 could be mounted on second shaft 52, wherein bulk material could be substantially directed from bulk material breaking means 26 to second bulk material breaking means 50, and wherein second shaft 52 could be positioned proximate to bar grating 54, thus enabling increased size adjustment of reclaimed bulk materials and prevention of passage of oversized clumps.

In an alternate embodiment, bulk material breaking means 26 could be mounted on a second shaft positioned proximate to shaft 24, whereby movement of reclaimer conveyor 29 and bulk material breaking means 26 could be linked.

In an alternate embodiment, bulk material breaking means 26 could be mounted on a second shaft positioned proximate to shaft 24, whereby movement of reclaimer conveyor 29 and bulk material breaking means 26 could be independent.

In an alternate embodiment, bulk material breaking means 26 could be mounted on shaft 24 to enable independent movement of bulk material breaking means 26 relative to shaft 24.

In an alternate embodiment, bulk material breaking means 26 could include a generally cylindrical, axially mounted drum, wherein the surface of the drum could be generally and protrudingly pointed.

In an alternate embodiment, bulk material breaking means 26 could include just one disc 30.

In an alternate embodiment, bulk material breaking means 26 could have any number of discs or plates 30a, 30b and 30c.

In an alternate embodiment, each disc or plate 30a, 30b and 30c of the plurality of plates 30 could be ridged, undulating or pyramidally shaped in lieu of being generally flat.

In an alternate embodiment, each of the plurality of generally flat triangular shaped projections 32 could be conical, cylindrical or pyramidal shaped projections or each disc or plate 30a, 30b and 30c could have more than one shape of projection thereon.

In use, bulk material is collected from a pile via reclaimer boom 14 and directed thereby toward main frame 16. As the reclaimed material being moved by reclaimer conveyor 29 approaches tail end 22 of reclaimer boom 14, contact is made with bulk material breaking means 26, thus enabling the aggressive treatment of the reclaimed material generally after it leaves the base of the bulk material pile and before it enters transfer chute 28. Substantially prior to and during exit of bulk materials from reclaimer conveyor 29, a plurality of discs 30 engage the material, utilizing teeth 32 to break any oversized, frozen or otherwise agglomerated pieces of bulk material.

Loose and appropriately sized bulk material then enters transfer chute 28, wherein the material is preferably directed onto a generally horizontal screw conveyor 27. Rotating augers 40 of screw conveyor 27 preferably meter and urge the reclaimed material toward central axis of foundation 20, wherein the reclaimed bulk material falls through exit chute 42 onto out-feed conveyor 44.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. An improved reclaimer device for manipulating bulk materials, comprising:
a reclaimer assembly having a main frame and a reclaim conveyor;
at least one breaking means carried proximate to said reclaim conveyor to enable aggressive manipulation of the bulk material prior to exiting said reclaim conveyor; and
a transfer chute, said transfer chute positioned to receive bulk materials from said reclaim conveyor following interaction with said breaking means.

2. The reclaimer device of claim 1, further comprising:
a metering conveyor, said metering conveyor positioned to receive bulk materials from said transfer chute;
an out-feed chute, said out-feed chute positioned to receive bulk materials from said metering conveyor; and
an out-feed conveyor.

3. The reclaimer device of claim 2, wherein said metering conveyor is generally horizontal.

4. The reclaimer device of claim 2, further comprising a central tower, wherein said metering conveyor is a screw conveyor and wherein said screw conveyor directs the bulk materials into a base of said central tower via said out-feed chute.

5. The reclaimer device of claim 1, further comprising:
a central tower having a base;
an out-feed chute, said out-feed chute positioned to receive bulk materials from said transfer chute, wherein said out-feed chute directs the bulk materials into said base of said central tower; and
an out-feed conveyor.

6. The improved reclaimer device of claim 1, wherein said at least one breaking means comprises:
a first substantially cylindrical rotational device carried proximate to said reclaim conveyor, said first substantially cylindrical rotational device having peripheral protrusions substantially therearound, and
a bar grating, said bar grating carried between said first substantially cylindrical rotational device and said transfer chute, and positioned to receive bulk materials and to enable passage of bulk materials into said transfer chute through said bars of said bar grating.

7. The improved reclaimer device of claim 6, wherein said at least one breaking means further comprises:
a second substantially cylindrical rotational device carried between said first substantially cylindrical rotational device and said transfer chute and positioned to receive bulk materials from said first substantially cylindrical rotational device, said second substantially cylindrical rotational device having peripheral protrusions substantially therearound, wherein said bar grating is carried proximate to said second substantially cylindrical rotational device and is positioned to receive bulk materials therefrom.

8. The improved reclaimer device of claim 1, wherein said reclaimer assembly is a linear traveling reclaimer.

9. The improved reclaimer device of claim 1, wherein said reclaimer assembly is a circular slewing reclaimer.

10. A breaking device for use with a reclaimer assembly, said breaking device for aggressively manipulating reclaimed bulk materials, comprising:
at least one rotatable disc having a plurality of peripherally carried projectiles, each said at least one rotatable disc carried proximate to the tail of the reclaimer assembly, wherein said plurality of peripherally carried projectiles breaks apart clumps of the reclaimed bulk material.

11. The improved method of reclaiming bulk materials comprising the steps of:
a. obtaining a reclaimer device having a plurality of engageable toothed discs rotationally carried proximate to a tail end of a reclaim conveyor, a transfer chute carried proximate to said tail end of said reclaim conveyor for receiving bulk materials therefrom;
b. collecting bulk materials via said reclaim conveyor, wherein the bulk materials are directed to said tail end of said reclaim conveyor;
c. rotatably engaging the bulk materials with said plurality of engageable toothed discs, thereby breaking any oversized, frozen or agglomerated materials; and
d. receiving the loose bulk materials into said transfer chute from said tail end of said reclaim conveyor and said plurality of engageable toothed discs.

12. The method of reclaiming bulk materials of claim 11, wherein said reclaimer device further comprises a first metering conveyor carried proximate to said transfer chute for receiving bulk materials therefrom, an exit chute carried proximate to said first metering conveyor for receiving bulk materials therefrom, and a second conveyor carried proximate to said exit chute for receiving bulk materials therefrom, and further comprising the steps of:
e. transferring the loose bulk materials from said transfer chute to said first metering conveyor;
f. conveying the loose bulk materials from said first metering conveyor to said exit chute;
g. receiving the loose bulk materials onto said second conveyor from said exit chute, wherein said second conveyor removes the loose bulk materials.

13. An improved reclaimer device for substantially eliminating oversized bulk materials substantially prior to and during exit of such materials from a reclaimer conveyer, comprising:
a bulk material breaking means carried between the base of the bulk material pile and a transfer chute, and
a transfer chute for directing the broken bulk materials to a generally horizontal conveyor;
wherein said bulk material breaking means is carried to enable movement with said reclaimer conveyor.

14. The improved reclaimer device of claim 13, wherein said bulk material breaking means includes a plurality of discs coaxially carried on a rotating shaft, wherein each said disc of said plurality of discs is generally flat, has a generally circular shape, and has a peripheral edge with a plurality of projections extending outwardly therefrom, and wherein said breaking means moves coincidentally with a reclaimer boom.

15. The improved reclaimer device of claim 14, wherein at least one projection of said plurality of projections is generally flat and generally triangular shaped.

16. The improved reclaimer device of claim 14, wherein at least one projection of said plurality of projections is generally conically shaped.

17. The improved reclaimer device of claim 14, wherein at least one projection of said plurality of projections is generally cylindrically shaped.

18. The improved reclaimer device of claim 14, wherein at least one projection of said plurality of projections is generally pyramidal shaped.

19. The improved reclaimer device of claim 14, further comprising a motor and a linkage, wherein said rotating shaft of said breaking means is rotated thereby.

20. The improved reclaimer device of claim 14, wherein said rotating shaft of said breaking means is coincident with the pivot of the reclaimer boom and motorized generation of conveyor movement necessarily generates rotational force for said rotating shaft of said breaking means.

21. The improved reclaimer device of claim 13, further comprising a peripheral wall, said peripheral wall substantially encircling a slew drive of said reclaimer device, wherein said transfer chute is positioned substantially within and proximate to said peripheral wall, proximate to a reclaimer boom base.

22. The improved reclaimer device of claim 14, wherein said transfer chute moves coincidentally with said reclaimer boom and said breaking means.

23. The improved reclaimer device of claim 1, wherein said at least one breaking means comprises a plurality of saw-toothed wheels axially aligned on a shaft and wherein movement of said reclaim conveyor engages coincident rotation of said shaft and cooperative rotational movement of said plurality of saw-toothed wheels.

24. The improved reclaimer device of claim 23, wherein said plurality of saw-toothed wheels is three generally circular-shaped plates, each said plate surrounded by a plurality of aggressive teeth.
